(19) United States
(12) Patent Application Publication
(10) Pub. No.: US 2020/0379376 A1
(43) Pub. Date: Dec. 3, 2020

(54) PROCESSES FOR APPLYING TRANSFER MATERIAL TO A SUBSTRATE SURFACE

(71) Applicant: Vivid Laminating Technologies Ltd, Ashby de la Zouch (GB)

(72) Inventor: Gavin Ward, Ashby de la Zouch (GB)

(21) Appl. No.: 16/887,301

(22) Filed: May 29, 2020

(30) Foreign Application Priority Data
May 31, 2019 (GB) 1907715.5

(51) Int. Cl. G03G 15/16; G03G 15/04

(52) U.S. Cl. CPC G03G 15/162; G03G 15/04072

(57) ABSTRACT

A process is described comprising the steps of applying a pattern of toner to the surface of a substrate, and adhering a layer of substantially transparent transfer material to the toner to define a matching pattern of transfer material. The process can be used to create raised or textured effects over a colour image.

### CROSS-REFERENCE TO RELATED APPLICATION(S)

This application claims priority to United Kingdom Patent Application No. 1907715.5, filed on May 31, 2019, the entire content of which is incorporated by reference herein.

### TECHNICAL FIELD

The present invention relates to a process where a layer of transfer material is applied to a pattern of toner on a substrate surface, and in particular to a process where the transfer material is substantially transparent and is applied on top of a visual image (e.g., a colour image) that is defined by the toner pattern to produce a raised or textured effect on the substrate surface that can enliven and enhance the visual image that is underneath the transfer material and is visible through it.

### BACKGROUND ART

In a known “toner foiling” process, a pattern of toner is applied to the surface of a substrate (e.g., a sheet of paper or card) by a suitable process such as laser printing. A transfer material is then adhered to the toner.

The transfer material is normally a multi-layer material that is releasably adhered to a backing material. The transfer material may include an adhesive layer that allows it to adhere to the toner, and a metallized or pigmented layer. The transfer material may be adhered to the toner using a heated roller, for example. Applying heat causes the toner to become tacky. Any transfer material that contacts the toner becomes adhered to it and may be released or peeled away from the backing material. Any transfer material that contacts the part of the substrate surface to which toner has not been applied remains adhered to the backing material. It will therefore be understood that the transfer material is applied to the substrate surface in a pattern that matches the pattern of the toner. The pattern of toner may be designed so that the layer of transfer material on the substrate surface represents a visual image that may include words, shapes or other graphical elements, for example. Normally just black toner is applied to the substrate because it is completely covered by the opaque transfer material. The toner is only applied to the substrate to define the pattern of transfer material that is subsequently adhered to it.

Rolls and sheets of transfer material and the adhered backing material are sold commercially as “foils” and are available in a wide variety of colours and metallized effects.

In another known print finish process, a printed image may be spot coated with a transparent coating material that is then dried to provide a surface texture to the printed substrate. Such a print finish process is provided by the DuSense “sensory coater” supplied by Duplo International Ltd. This uses an inkjet printer to print transparent coating material with raised finishes that resemble embossing. Texturing may be controlled by height mapping in the artwork files. Such printing machines are extremely expensive.

Accordingly, there is a need to provide similar texturing to a substrate surface without the need for specialist printing machines.

### SUMMARY OF THE INVENTION

The present invention relates to a process comprising the steps of:
applying a pattern of toner to the surface of a substrate,
adhering a substantially transparent transfer material to the toner, and
releasing the adhered transfer material from a backing material to define a matching pattern of transfer material.

Applying a layer of transfer material to the substrate surface in a desired pattern that is determined by the pattern of the toner provides a raised or textured effect at a significantly lower cost than known print finish processes. The transfer material defines one or more raised areas that extend above the substrate surface. The height of these raised areas is determined by the thickness of the transfer material that is adhered to the toner. In some cases, two or more layers of transfer material may be applied on top of each other to create raised areas with different heights (e.g., a contoured surface) to create different textured effects. Different transfer materials with different thicknesses may also be used.

The pattern of toner may be applied to the substrate surface by a printing process, e.g., using a laser printer.

After the layer of transfer material has been adhered to the toner, the process may further comprise the step of:
printing a visual image (e.g., a colour image) on an upper surface of the transfer material using a laser printer or other suitable printing process, for example. The visual image may also be printed on the substrate surface, for example on that part of the substrate surface that lies outside the pattern of transfer material.

The pattern of toner may define a first visual image (e.g., a first colour image) that is visible through the layer of transfer material after it has been adhered to the toner. The process may further comprise the step of:
printing a second visual image (e.g., a second colour image) on an upper surface of the transfer material using a laser printer or other suitable printing process, for example. The second visual image may also be printed on the substrate surface, for example on that part of the substrate surface that lies outside the pattern of transfer material. The process may further comprise the step of printing a second visual image (e.g., a second colour image) just on the substrate surface. In this case, a combined visual image that is printed on the substrate surface may comprise the first and second visual images—where part of the combined visual image is covered by the transfer material and part is not covered by the transfer material.

In one arrangement, the substrate is passed through a laser printer to print the toner pattern as a first visual image and define the part of the substrate surface to which the transfer material is to be adhered. After the transfer material is adhered to the substrate surface, the substrate is passed through a laser printer for a second time to print the second visual image. The second visual image may be printed on one or both of the substrate surface and the upper surface of the layer of transfer material which is specifically adapted to be printed.

If the second visual image is a pattern of toner that is applied to the upper surface of the transfer material, it may be possible to adhere a second layer of transfer material on top of the first layer to create different heights or textured effects. The transfer material that forms the second layer may be the same as the transfer material that forms the first layer, or it may be different (e.g., different thickness or different optical properties).

In one arrangement, the substrate is passed through a laser printer to print a first toner pattern and define a first part of the substrate to which a first transfer material is to be adhered. After the first transfer material is adhered to the substrate surface, the substrate is passed through a laser printer for a second time to print a second toner pattern and define a second part of the substrate to which a second transfer material is to be adhered. The first and second transfer materials may have different characteristics, e.g., different thickness or different optical properties. The first and second toner patterns may together define a combined visual image or separate visual images.

It will be understood that the transfer material will be similar to conventional foils for toner foiling but is substantially transparent. This includes transfer materials that are transparent or translucent so that any underlying visual image may be seen through the transfer material by the naked eye, for example. Both optically transparent and translucent transfer materials will allow the passage of light and can also be used to provide coloured effects, i.e., by absorbing or scattering certain wavelengths of light. As described in more detail below, the transfer material is releasable from a suitable backing material. Any transfer material that is not adhered to the toner will remain adhered to the backing material and is removed with it.

The substrate may be any suitable material including paper or card, plastics sheet or film, woven or non-woven fabric, leather or simulated leather, for example.

The transfer material may be adhered to the toner using a heated roller, for example. In particular, the transfer material may be positioned in direct contact with the substrate surface and the roller may be used to apply heat and pressure to the backing material to adhere the transfer material to the toner. The apparatus for adhering the transfer material to the toner may be of any suitable type and construction.

The present invention further relates to a preferred process comprising the steps of:
laser printing a pattern of toner on the surface of a substrate to define a visual image,
adhering a substantially transparent transfer material to the toner, and
releasing the adhered transfer material from a backing material to define a matching pattern of transfer material,
wherein the visual image is visible through the adhered transfer material.

The present invention further relates to a substantially transparent transfer material releasably adhered to a backing material and specifically adapted for use with the process described above.

The present invention further relates to a substantially transparent transfer material having a first planar surface specifically adapted to be adhered or adherable to toner applied to the surface of a substrate, and a second planar surface, opposite the first planar surface, specifically adapted to be printed or that is printable, i.e., to which printing may be applied, and is releas ably adhered to a backing material. The first planar surface is specifically adapted to be adhered to the toner in the same way as conventional foils for toner foiling.

The transfer material may have a single- or multi-layer construction and comprise any suitable material or materials, e.g., a thermoplastic polymer or polymers. If the transfer material has a multi-layer construction, the layers may be made of different materials or have different properties. A first layer (e.g., an adhesive layer) that defines the first planar surface may comprise a material that is specifically adapted to provide adhesion to the toner, and a second layer that defines the second planer surface may comprise a material that is specifically adapted to be printed. A third (or intermediate) layer may be provided between the first and second layers. The transfer material may have any suitable overall thickness but in practice this may be limited by the subsequent printing process—for example, some printers may only be able to handle substrates of a certain thickness, including the layer of adhered transfer material. An example of an overall thickness may be about 40 μm.

The second surface is releasably adhered to a backing material. The backing material may comprise any suitable material, e.g., a thermoplastic polymer such as polyethylene terephthalate (or PET). The backing material may have any suitable thickness. An example of a thickness may be about 12 μm. The transfer material and the adhered backing material may be supplied as rolls or sheets.

### DRAWINGS

FIG. 1 is top view of a substrate to which a pattern of toner has been applied;

FIG. 2 is a top view of the substrate of FIG. 1 where a matching pattern of transfer material has been adhered to the toner;

FIG. 3 is a top view of the substrate of FIG. 2 where a second pattern of toner has been applied to the layer of transfer material;

FIG. 4 is a top view of the substrate of FIG. 2 where a second pattern of toner has been applied to the layer of transfer material and the substrate;

FIG. 5 is a top view of the substrate of FIG. 3 where a matching pattern of transfer material has been adhered to the second pattern of toner to form a second layer of transfer material;

FIG. 6 is a side view of the substrate of FIG. 5;

FIG. 7 is a top view of the substrate of FIG. 2 where a second pattern of toner has been applied to the substrate and a matching pattern of transfer material has been applied to the second pattern of toner;

FIG. 8 is a side view of the substrate of FIG. 7;

FIG. 9 is a side view of transfer material and backing material; and

FIG. 10 is a schematic view showing how the transfer material is adhered to the toner.

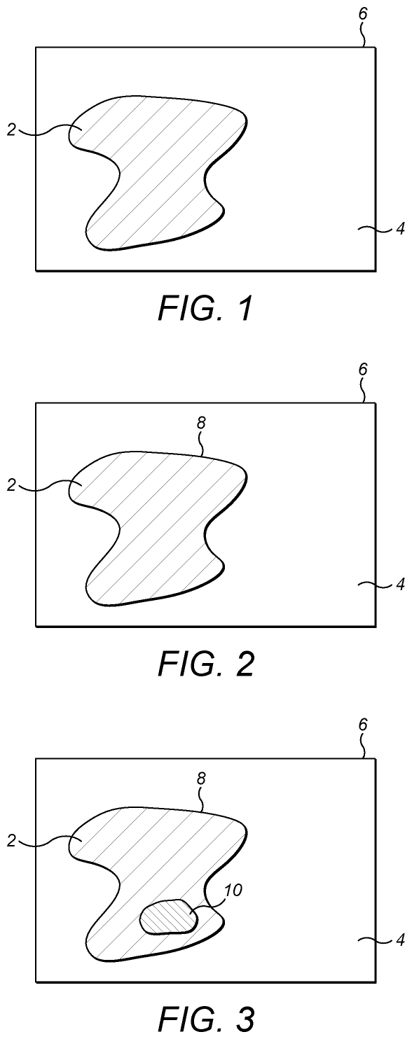

In an example of the process according to the present invention, a pattern of toner defining a first colour image 2 is applied to the surface 4 of a substrate 6 using a laser printer (FIG. 1). A layer 8 of transfer material is adhered to the toner to define a matching pattern of transfer material (FIG. 2). The transfer material is substantially transparent so that the first colour image 2 is visible through the layer 8 of transfer material.

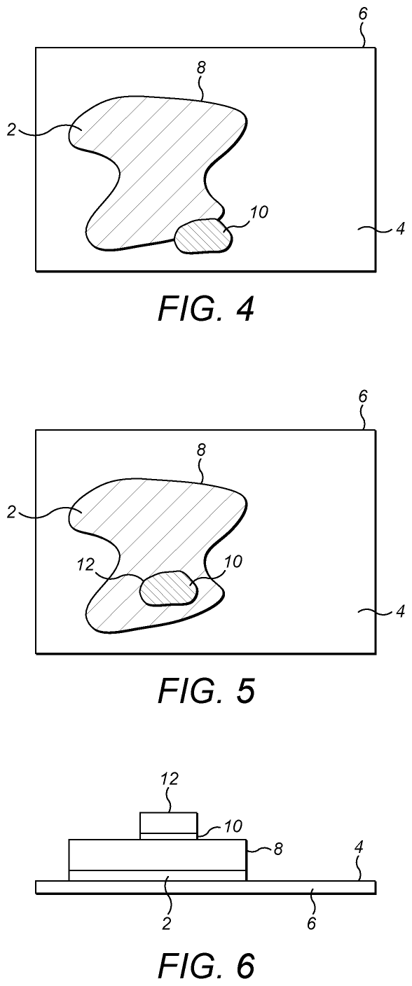

In another example of the process according to the present invention, a pattern of toner defining a second colour image 10 is printed on top of the layer 8 of transfer material using a laser printer (FIG. 3). The second colour image 10 may also extend onto the surface 4 of the substrate (FIG. 4).

In another example of the process according to the present invention, a second layer 12 of transfer material is adhered to the toner on top of the first layer 8 of transfer material (FIGS. 5 and 6), i.e., the toner defining the second colour image 10. The transfer material is substantially transparent so that the second colour image 10 is visible through the second layer 12 of transfer material. It will be understood that by applying layers of transfer material on top of each other, textured effects can be created where the transfer material has a contoured surface. The transfer materials in each layer may be the same or different.

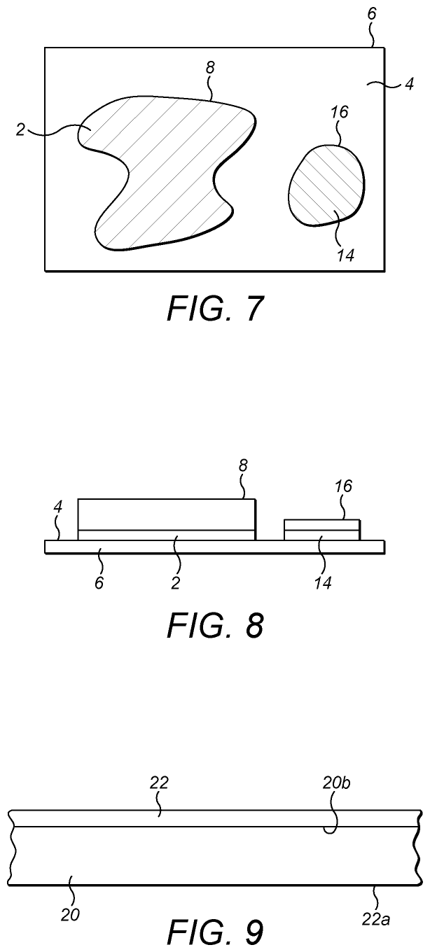

In another example of the process according to the present invention, a pattern of toner defining a second colour image 14 is applied to the surface 4 of the substrate 6 shown in FIG. 2 using a laser printer (FIGS. 7 and 8). A second layer 16 of transfer material is adhered to the toner. The transfer material is substantially transparent so that the second colour image 14 is visible through the second layer 16 of transfer material. The transfer materials may be the same or different. In this example, the transfer materials in the first and second layers have different thicknesses as shown in FIG. 9. It will be understood that if the layers of transfer material are contiguous, textured effects can be created where the transfer material has a contoured surface.

Referring to FIG. 9, the transfer material 20 is releasable from a suitable backing material 22 and the process of adhering the transfer material to the toner will typically comprise releasing the adhered transfer material from the backing material. Any transfer material that is not adhered to the toner will remain adhered to the backing material and is removed with it. The transfer material 20 has a first planar surface 20a specifically adapted to be adhered to toner applied to the surface of a substrate, and a second planar surface 20b, opposite the first planar surface, specifically adapted to be printed, i.e., to which printing may be applied. The first planar surface 20a is specifically adapted to be adhered to the toner in the same way as conventional foils for toner foiling.

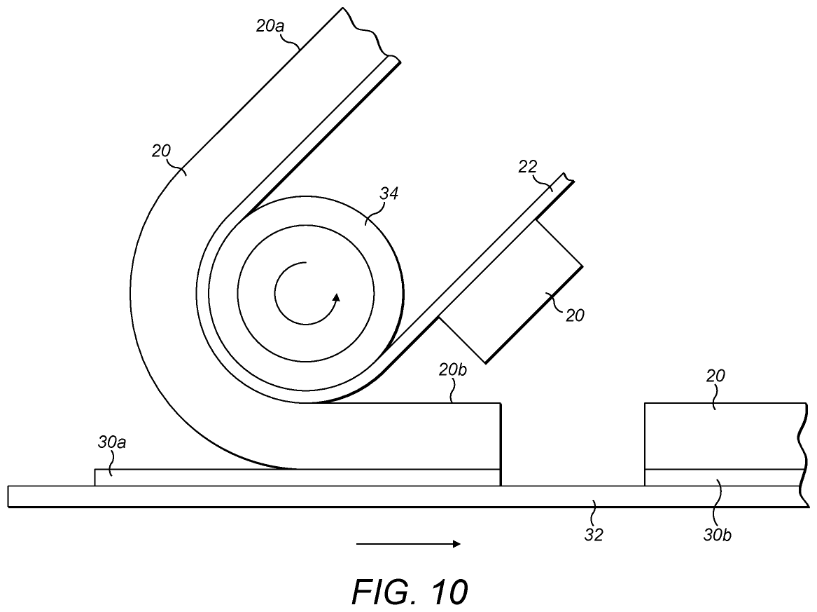

FIG. 10 shows how a layer of transfer material 20 can be adhered to the pattern of toner that defines a colour image. Two distinct areas of toner 30a, 30b are shown applied to a surface of a substrate 32. Although in FIG. 10 the toner is applied to the substrate surface, the same process can be used to adhere transfer material to toner that has been applied to the surface of an existing transfer material layer. The transfer material 20 is adhered to the toner using a heated roller 34 which heats the toner and makes it tacky and which applies pressure to the transfer material. There is relative lateral movement between the roller 34 and the substrate 32. The transfer material 20 only adheres to the toner and part of the transfer material that has not been adhered to the toner remains adhered to the backing material 22 as shown in FIG. 10.

1. A process comprising the steps of:
applying a pattern of toner to the surface of a substrate,
adhering a substantially transparent transfer material to the toner, and
releasing the adhered transfer material from a backing material to define a matching pattern of transfer material.

2. The process of claim 1, wherein the pattern of toner is applied to the substrate surface by a printing process.

3. The process of claim 2, wherein the printing process uses a laser printer.

4. The process of claim 1, further comprising the step of:
printing a visual image on an upper surface of the transfer material.

5. The process of claim 4, wherein the visual image is printed using a laser printer.

6. The process of claim 1, wherein the pattern of toner defines a first visual image that is visible through the transfer material.

7. The process of claim 6, further comprising the step of:
printing a second visual image on an upper surface of the transfer material.

8. The process of claim 7, wherein the second visual image is printed using a laser printer.

9. The process of claim 1, further comprising the steps of:
applying a second pattern of toner to the surface of the substrate, and
adhering a substantially transparent transfer material to the second pattern of toner to define a matching pattern of transfer material.

10. The process of claim 9, wherein the transfer material that is adhered to the pattern of toner is different to the transfer material adhered to the second pattern of toner.

11. The process of claim 1, wherein the transfer material is adhered to the toner using a heated roller.

12. A process comprising the steps of:
laser printing a pattern of toner on the surface of a substrate to define a visual image,
adhering a substantially transparent transfer material to the toner, and
releasing the adhered transfer material from a backing material to define a matching pattern of transfer material,
wherein the visual image is visible through the adhered transfer material.

13. A substantially transparent transfer material releasably adhered to a backing material and specifically adapted for use with the process according to claim 1.

14. A substantially transparent transfer material having a first planar surface adherable to toner applied to the surface of a substrate, and a second planar surface, opposite the first planar surface, that is printable and is releasably adhered to a backing material.
